(19) United States
(12) Patent Application Publication
(10) Pub. No.: US 2016/0006237 A1
(43) Pub. Date: Jan. 7, 2016

(54) METHOD AND DEVICE FOR SAFE VOLTAGE CONNECTION OF A DRIVE INVERTER

(71) Applicant: BAUMUELLER NUERNBERG GMBH, NUERNBERG (DE)

(72) Inventors: AXEL HELMERTH, WILNSDORF (DE); MAGDI DIMAS-ZEKRI, NUERNBERG (DE); UWE HENSEL, NUERNBERG (DE)

(21) Appl. No.: 14/854,239

(22) Filed: Sep. 15, 2015

Related U.S. Application Data
(63) Continuation of application No. PCT/EP2013/003884, filed on Dec. 20, 2013.

(30) Foreign Application Priority Data
Mar. 15, 2013 (DE) 102013004451.0

(51) Int. Cl. H02H 7/08; H02P 27/06

(52) U.S. Cl. CPC H02H 7/0844; H02P 27/06

(57) ABSTRACT

A device and a method connect and reliably separate a voltage terminal of a drive inverter for an electric machine to or from a supply voltage. The device contains a connection and interruption circuit with two switching branches connected between a supply voltage terminal of the supply voltage and the voltage terminal of the drive inverter. A control and/or regulating device is programmed and/or the circuitry of which is configured to connect the supply voltage to the voltage terminal of the drive inverter via the switching branches and to deactivate one of the switching branches in a first test mode and to read a sensor signal from the switching branch while the other switching branch is activated and conducts the supply voltage to the voltage terminal of the drive inverter.

### CROSS-REFERENCE TO RELATED APPLICATION

This is a continuation application, under 35 U.S.C. §120, of copending international application No. PCT/EP2013/003884, filed Dec. 20, 2013, which designated the United States; this application also claims the priority, under 35 U.S.C. §119, of German patent application No. DE 10 2013 004 451.0, filed Mar. 15, 2013; the prior applications are herewith incorporated by reference in their entirety.

### BACKGROUND OF THE INVENTION

### Field of the Invention

The invention relates to an apparatus and a method for connecting and safely isolating a voltage connection of a drive inverter for an electrical machine to and from a supply voltage. In this case, the term “safely” is understood as meaning the compliance with a safety function, in particular the safe torque function (STO).

In the field of drive technology with electrical machines, in particular with synchronous or asynchronous motors, safety-oriented functions are required in order to reliably avoid injuries as a result of unwanted or unexpected rotations of the drives. In this case, an important safety function is safe stopping of the drive, which is referred to as safe-torque-off (STO). In this case, the drive is safely isolated from its energy supply in order to cause immediate stopping after the safety function has been triggered.

In the case of three-phase motors which are usually fed in a controlled manner using inverters and, in particular, using frequency converters, the or each safety function is controlled or triggered at the inverter or frequency converter by isolating the latter, and therefore also the three-phase motor or the electrical machine, from the energy supply. A 24 V DC input voltage is usually used to supply energy to the inverter or converter referred to as the drive inverter below, which input voltage is supplied to the drive inverter via a switch, for example a relay. If the switch is actuated during a stop function for switching off the machine, the input voltage needed to control the frequency converter and therefore its supply are switched off.

U.S. Pat. No. 7,868,619 B2 discloses a safe-torque-off connection (STO function) in which the 24 V input voltage for the control device and for the drivers of the circuit breakers or power semiconductor switches of the frequency converter, which are driven by the control device, and therefore the power supply for the electrical machine are interrupted using a two-pole switch.

### SUMMARY OF THE INVENTION

The invention is based on the object of specifying a particularly suitable apparatus and an improved method for safely operating an electrical machine. In particular, the intention is to ensure safe isolation of an inverter or converter of the electrical machine from a supply voltage. In addition, the intention is preferably to also specify reliable control of a safety function of the electrical machine even in the case of an input voltage of greater than or equal to 60 V, in particular with a power loss which is as low as possible at the same time.

According to the invention, in order to connect and safely isolate a voltage connection of a drive inverter for an electrical machine to and from a supply voltage, a connecting and isolating circuit, which is connected between a connection for the supply voltage and the voltage connection, and a control and/or regulating device are provided. The control and/or regulating device is preferably provided and set up, in terms of circuitry and/or programming, to test the functionality and/or functional safety of the connecting and isolating circuit, in particular.

The connecting and isolating circuit contains two switching branches which are connected between the connection for the supply voltage and the voltage connection of the drive inverter and are used to connect the supply voltage to the voltage connection of the drive inverter using the control and/or regulating device. In a first test mode, the control and/or regulating device switches off one of the switching branches and reads a sensor signal from the latter, while the other switching branch is switched on and passes the supply voltage to the voltage connection of the drive inverter.

During a more detailed test cycle, the function modes of the two switching branches are swapped and, in this respect, the other switching branch is switched off and a corresponding sensor signal is read from the latter, while the parallel switching branch is switched on and now passes the supply voltage to the voltage connection of the drive inverter. This makes it possible to test the functionality of the two switching branches of the test circuit in a preferably cyclical manner and at virtually any desired intervals of time without the voltage level at the voltage connection of the drive inverter changing. This makes it possible to safely test the connecting and interrupting or isolating function of the two switching branches in a simple and reliable manner during operation of the drive inverter and therefore while the electrical machine is operating.

In one advantageous configuration of the switching branches, they are substantially each provided with a semiconductor switch, which is connected between the connection for the supply voltage and the voltage connection of the drive inverter and is connected, on the drive side, to the control and/or regulating device. A sensor tap which is expediently connected between the respective semiconductor switch, in particular on the emitter or source side, and a diode is connected to the control device and provides the latter with the voltage level currently tapped off during the first test mode.

The voltage level sensed in the respective switching branch reliably provides information on the functionality of the respective semiconductor and therefore of the corresponding switching branch. If the corresponding voltage level has dropped to zero (0 V) when the semiconductor is switched off, the functionality of the corresponding semiconductor is assumed since it is recognized that, in the case of a defective semiconductor switch or a semiconductor switch operating incorrectly, its controllable current path (between the source and the drain in a field effect transistor or between the collector and the emitter in a bipolar transistor) is fundamentally short-circuited. In the event of a fault, a level which is different from zero and corresponds to the supply voltage could therefore be expected at the sensor tap.

According to one particularly expedient development, the connecting and isolating circuit is redundant. With respect to this development, the invention is based on the consideration that the drive inverter which is regularly in the form of a full-bridge, in particular in a B6 circuit accordingly having six power semiconductors, for example, which are often driven via optocouplers, usually has a so-called high side and a low side with respect to the voltage supply thereof. Therefore, in order to switch off the drive inverter in a particularly safe manner, both the high side and the low side are preferably isolated from the supply voltage. For this purpose, the redundant connecting and isolating circuit preferably has two test channels which are connected, on the output side, to one of the two connection sides in each case, that is to say the high side and the low side of the drive inverter.

The control and/or regulating device is suitably set up, in terms of circuitry and/or programming, to interrupt the connection established via the switching branches of the connecting and isolating circuit between the supply voltage and the voltage connection of the drive inverter. The interruption is carried out, in particular, as a result of a safety function, in particular the so-called safe-torque-off function, being triggered or activated.

In order to increase the safety in the event of the connection between the supply voltage and the voltage connection of the drive inverter being interrupted, provision is made of a drivable isolating circuit which is used to connect the voltage connection of the drive inverter to the reference potential, in particular ground, of the supply voltage. For this purpose, the isolating circuit expediently has two semiconductor switches which are connected in series, can be driven using the control and/or regulating device and between which is formed a center tap which is connected to the control and/or regulating device.

A voltage divider is expediently connected in parallel with the semiconductor switches of the isolating circuit, the center, divider or level tap of which is likewise connected to the control and/or regulating device. The center tap of the voltage divider is preferably connected to the tap between the two semiconductor switches. An additional detection or sensor connection to the control and/or regulating device is therefore dispensed with.

During the interruption of the connection established via the switching branches of the connecting and isolating circuit between the supply voltage and the voltage connection of the drive inverter, the control and/or regulating device generates a control signal for the isolating circuit in order to connect the voltage connection of the drive inverter to the reference potential of the supply voltage.

When the voltage connection is isolated from the supply voltage, the control and/or regulating device records the voltage or voltage level at the tap between the semiconductor switches in a second test mode. This voltage level is always evaluated when a first of the two semiconductor switches of the isolating circuit is switched on and the second semiconductor switch is switched off or, vice versa, when the second of the two semiconductor switches of the isolating circuit is switched on and the first semiconductor switch is switched off. If, depending on the switching state of the two semiconductor switches of the isolating circuit, the voltage level at the tap of the semiconductor switches assumes the level at the voltage connection of the drive inverter or the level close to the reference potential of the supply voltage in this second test mode, safe functionality of the connecting circuit can be assumed. A more detailed test is carried out by detecting the voltage level at the center tap of the voltage divider when both semiconductor switches of the connecting circuit are switched off.

The functional test in the second test mode is used to ensure a reliable connection between the voltage connection of the drive inverter and the reference potential of the supply voltage when, for example as a result of a safety function being triggered, reliable isolation of the drive inverter from the supply voltage needs to be ensured in order to consequently reliably ensure that the electrical machine is stopped. Like in the first test mode, the functionality of the safe switching-off of the drive inverter can also be tested during its operation in the second test mode.

On account of a redundant configuration of both the connecting and interrupting circuit and the isolating circuit between the connection of the drive inverter and the reference potential of the supply voltage, it is possible, if a fault is diagnosed in one of the corresponding test channels, for the other redundant test channel to also safely switch off and isolate the drive inverter. Therefore, even in the event of a fault in one of the redundant test channels, the other redundant circuit, that is to say the other test channel, can alone switch the electrical machine and therefore the drive in a torque-free manner. For this purpose, the two redundant circuits or test channels are suitably linked to one another in a suitable manner in order to carry out the safe switching-off and connection isolation, when a fault is diagnosed in one of the circuits, using the redundant other circuit.

The apparatus according to the invention therefore allows a reliable test in order to determine whether reliable switching-off and isolation of the voltage connection of the drive inverter from the supply voltage is ensured using the connecting and isolating circuits without having to experimentally switch it off. As long as the test of the connecting and isolating circuit, on the one hand, and of the isolating circuit between the voltage connection of the drive inverter and the reference potential of the supply voltage functions in a fault-free manner, it can be assumed that the drive inverter can be isolated from the supply voltage and can therefore be safely switched off if desired or required for reasons of safety.

In another expedient development of the apparatus, it has a converter circuit, in particular a converter circuit which is again redundant, which contains a transformer having, on the primary side, a semiconductor switch for providing a potential-isolated output voltage from an input voltage and contains, on the secondary side, a rectifier. The control and/or regulating device is connected downstream of the rectifier, the control and/or regulating device which is, in particular, likewise redundant being set up, in terms of circuitry and/or programming, to generate a control signal for the drive inverter for the purpose of triggering a safety function and a drive signal for the semiconductor switch when the output voltage exceeds a maximum value.

In this case, a potential-isolated DC output voltage is generated from a DC input voltage and is used to generate a control signal for the drive inverter for the intended operation of the latter and for triggering the safety function. A drive signal for the semiconductor switch which is periodically connected to the input voltage is also generated and the output voltage is reduced or limited when the output voltage exceeds a switching threshold or a threshold value.

In this respect, the invention is based on the consideration that a voltage divider circuit, possibly with a downstream optocoupler for DC isolation, could indeed be used to also master a relatively large voltage range of the input voltage of greater than or equal to 60 V in an extremely simple manner. However, the disadvantage of such high input voltages is the correspondingly high power loss at the non-reactive resistors of the voltage divider. The use of a constant current source with a possibly downstream optocoupler also results in undesirably high power losses with an accordingly high input voltage at the level of the required 60 V. Known voltage limitation circuits could also be used to limit voltage increases which occur in the event of a fault to the 24 V input voltage. However, such voltage limitation circuits do not ensure that the required safety function is ensured without influence and undesirable switching-off of the input voltage is reliably prevented.

In contrast, the apparatus developed according to the invention is intended and set up to allow an operating situation with an increased input voltage of, for example, 60 V even for a digital input of a downstream control circuit for the drive inverter with a simultaneously low power loss and to reliably ensure the required safety function, in particular the STO function.

In this case, the converter circuit is, in terms of circuitry, in the form of a clocked voltage converter which operates, for example, as a flyback converter or else as a forward converter and converts the DC input voltage, which is usually 24 V, into a DC output voltage which is made available to a device for generating a control signal for the frequency converter.

The control and/or regulating device connected downstream of the rectifier is also set up, in terms of circuitry and/or programming, to generate a clocked drive signal for the semiconductor switch of the converter circuit when the input voltage, and therefore the output voltage, of the device exceeds a predefined maximum value. If the output voltage exceeds the maximum value, it is limited using control or regulating technology on account of the drive signal. For this purpose, the device is connected, on the drive side, to the semiconductor switch via a feedback loop, preferably having a DC-isolating element in the form of an optocoupler, in particular. The feedback loop expediently contains a pulse modulator for setting the operating frequency of the semiconductor switch on the basis of the clock or drive signal generated by the device. In this case, the pulse modulator is suitably a pulse width modulator (PWM) and/or a pulse pause modulator (PPM) for setting the duty factor of the clock or drive signal for the semiconductor switch.

The control and/or regulating device preferably has a comparator and threshold value switch function to which the output voltage of the converter circuit is applied and which is intended to activate the drive signal for the semiconductor switch. The control and/or regulating device also suitably contains a desired/actual comparator and a pulse modulator which is connected downstream of the latter and is intended to set the operating frequency of the semiconductor switch on the basis of a deviation of the output voltage from a desired value.

In one expedient configuration of this apparatus, a threshold value switch is assigned to the control and/or regulating device, the output voltage of the converter circuit being supplied to the threshold value switch for the purpose of generating a binary control signal for the drive inverter. The threshold value switch is suitably implemented using software, for example in the form of a Schmitt trigger functionality. The control signal preferably carries a high level for operating the drive inverter when the output voltage exceeds an upper threshold value and a low level which triggers the safety function when the output voltage undershoots a lower threshold value.

Like the control and/or regulating device, the converter circuit is expediently redundant. The functionality of the control and/or regulating device, in particular including its comparator and threshold value switch function, is also suitably integrated in two redundant microprocessors, the inputs of which for the output voltage of the converter circuit are coupled to the respective other microprocessor.

The semiconductor switch of the converter is particularly preferably connected, on the control side, to the control and/or regulating device via a DC-isolating element in the form of an optocoupler. In one particularly preferred variant of the converter circuit, the semiconductor switch or, in the case of a redundant design, each semiconductor switch forms a series circuit with the primary winding of the transformer, to which series circuit the input voltage is applied. A capacitor for buffering the input voltage which usually fluctuates at least slightly is suitably connected in parallel with the series circuit. The control input (gate) of the semiconductor switch, which is preferably in the form of a MOSFET, is expediently connected to this buffer capacitor via the phototransistor of the DC-isolating optocoupler.

The advantages achieved with this developed apparatus consist, in particular, of the fact that a comparatively large or wide input voltage range of more than 60 V is mastered safely and, in particular with regard to the apparatus according to the invention, in an intrinsically safe manner and with only a low power loss by using a converter circuit to control a safety function of an electrical machine. On account of the redundant structure of the converter circuit and of the device for triggering the safety function, in particular the STO function, and their mutual monitoring, the safety and intrinsic safety of the apparatus according to the invention are increased further.

Other features which are considered as characteristic for the invention are set forth in the appended claims.

Although the invention is illustrated and described herein as embodied in a safe voltage connection of a drive inverter, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of a drive controller of an electrical machine having an apparatus for connecting and isolating, in terms of voltage, a drive inverter of the electrical machine to and from a supply voltage according to the invention;

FIG. 2 is a schematic diagram of a redundant connecting and isolating circuit of the apparatus;

FIG. 3 is a block diagram of the drive controller having a converter circuit on the input side for triggering a safety function and for limiting the voltage; and

FIG. 4 is a circuit diagram of the structure of the converter circuit which is redundant in terms of circuitry with a downstream device for triggering the safety function with mutual monitoring.

### DETAILED DESCRIPTION OF THE INVENTION

Parts which correspond to one another are provided with the same reference symbols in all figures.

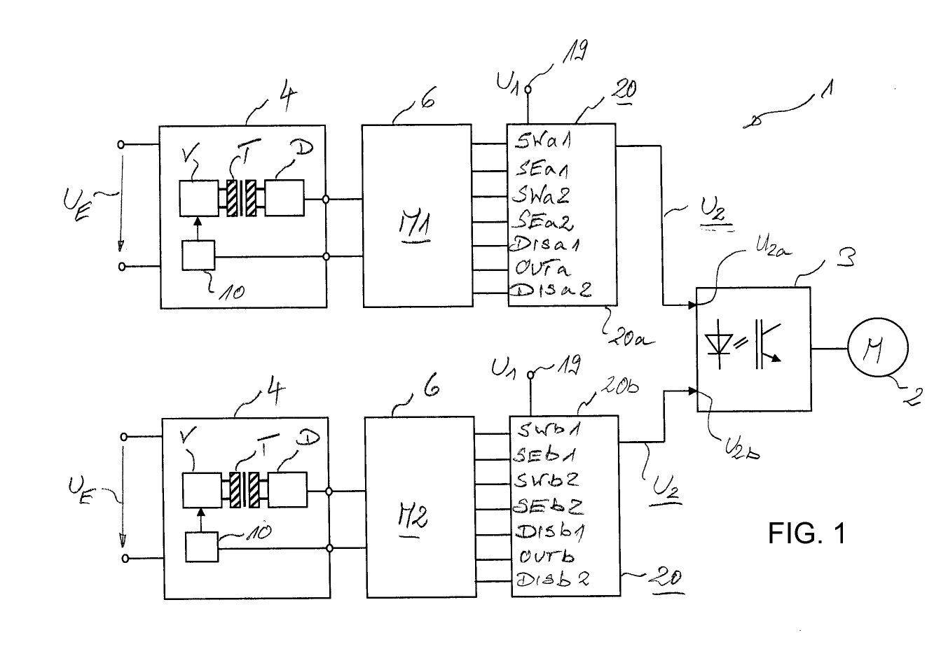

Referring now to the figures of the drawings in detail and first, particularly to FIG. 1 thereof, there is shown a drive controller 1 of a three-phase motor 2 as an electrical machine which is operated using a drive or frequency converter 3. In a redundant design, the drive controller 1 contains a clocked converter circuit 4 having a transformer T which has a semiconductor switch V connected upstream of it on the primary side and a rectifier D connected downstream of it on the secondary side. The drive controller 1 also contains a control and regulating device 6 which is again redundant and, in conjunction with a connecting and interrupting circuit 20, forms an apparatus for connecting and safely isolating a voltage connection U₂ of the drive converter 3 to and from a supply voltage U₁. The connecting and interrupting circuit 20 is likewise redundant and has two test channels 20a and 20b for this purpose. The connecting and interrupting circuit 20 and its two test channels 20a and 20b each have inputs SWa1, SWa2, DISa1 and DISa2 and SWb1, SWb2, DISb1 and DISb2. The connecting and interrupting circuit 20 and its two test channels 20a and 20b also each have outputs SEa1, SEa2 and OUTa and SEb1, SEb2 and OUTb.

The test channel 20a is connected, on the output side, to a first connection side U₂ₐ, namely the so-called high side, of the drive inverter 3 which is preferably in the form of a B6 bridge circuit with optocouplers and power semiconductors. In a similar manner, the second test channel 20b of the supply and isolating circuit 20 is connected, on the output side, to the second connection side U_{2b}, namely the low side, of the drive inverter 3.

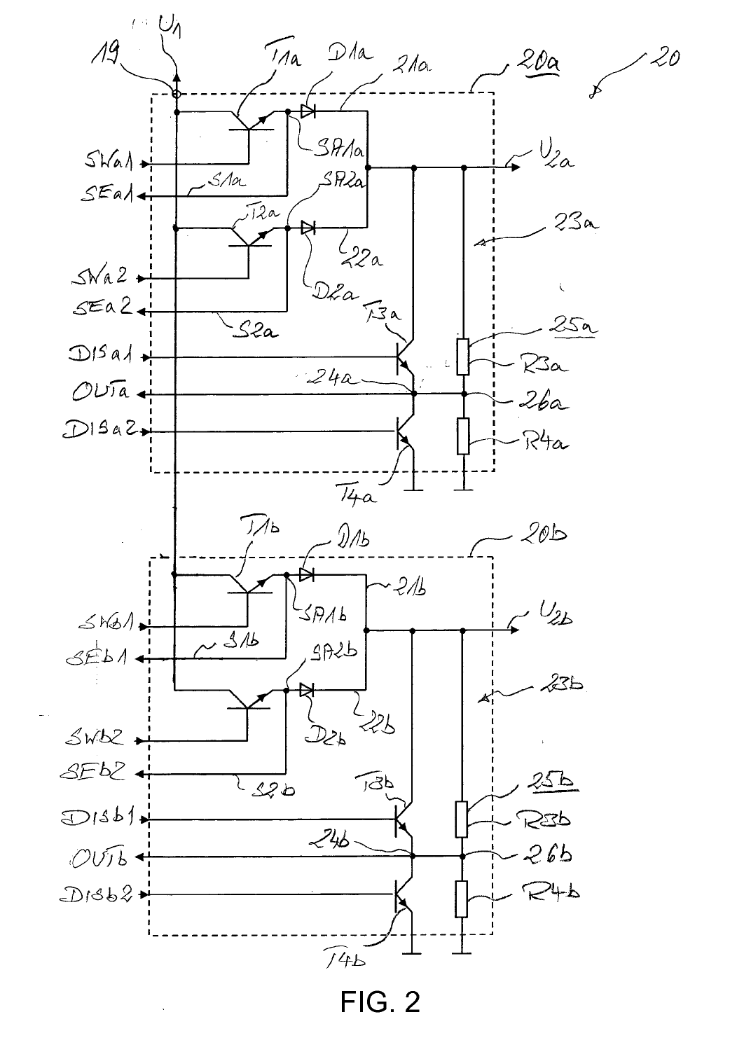

FIG. 2 shows the two-channel connecting and isolating circuit 20 in its preferred embodiment in terms of circuitry. The two test channels 20a and 20b have the same structure in terms of circuitry, with the result that the respective circuit and its functionality are described below using the example of the first test channel 20a. The second test channel 20b having the same structure contains the additional letter b for the individual circuit parts instead of the letter a for the circuit parts of the first test channel 20a described in more detail.

Each of the test channels 20a, 20b has two switching branches 21a, 22a which have the same structure and are jointly connected, on the one hand, to the supply voltage U₁ or to a corresponding connection 19 and, on the other hand, to the voltage connection of the drive inverter 3 which is denoted using U₂ₐ, U_{2b} and are therefore connected between the supply voltage U₁ and the corresponding voltage connection U₂ₐ and U_{2b} of the drive inverter 3. The switching branches 21a and 22a each have a series circuit containing a semiconductor switch T1a, T2a and a diode D1a and D2a. A sensor tap SA1a and SA2a is provided between the respective semiconductor switch T1a, T2a and the diode D1a, D2a and is connected to the respective output SEa1 and SEa2 of the corresponding test channel 20a. The inputs SWa1 and SWa2 are connected to the control inputs or connections of the respective semiconductor switch T1a and T2a. The respective test channel 20a, 20b also has an isolating circuit 23a and 23b. The isolating circuit 23a, 23b is connected between the voltage connection U₂ₐ and U_{2b} of the drive inverter 3 and the reference potential (ground) of the supply voltage U₁.

The isolating circuit 23a which is again described below only using the first test channel 20a has an identical design in the second test channel 20b and is again provided there with the letter b with regard to the circuit parts.

The isolating circuit 23a contains a series circuit having two semiconductor switches T3a which are assigned a center tap 24a which is connected to the output OUTa of the corresponding test channel 20a of the connecting and interrupting circuit 20. The isolating circuit 23a also contains a voltage divider 25a which is connected in parallel with the semiconductor switches T3a, T4a which are connected in series. The voltage divider 25a contains two non-reactive resistors R3a, R4a with an assigned divider or potential tap 26a. The latter is connected to the center tap 24a and is therefore likewise connected to the output OUTa of the corresponding test channel 20a. The two semiconductor switches T3a, T4a are connected, on the drive side, to the inputs DISa1 and DISa2 of the corresponding test channel 20a.

In a first test mode, the semiconductor switches T1a and T2a are preferably alternately controlled into the off state using the control and/or regulating device 6, with the result that the corresponding switching branch 21a and 22a is switched off. In this state, the control and/or regulating device 6 reads a sensor signal S1a, S2a which indicates the respective voltage level at the corresponding sensor tap SA1a and SA2a. If the recorded or sensed voltage level is equal to zero, that is to say 0 V in particular, when the transistor T1a, T2a is controlled into the off state and therefore in the switching branch 21a and 22a which is respectively switched off, the functionality and functional safety of the corresponding switching branch 21a, 22a of the respective test channel 22a is assumed.

During the first test mode, the corresponding semiconductor switch T2a and T1a in the respective other switching branch 22a, 21 a is turned on by a corresponding driving using the control and/or regulating device 6, that is to say the corresponding switching branch 22a, 21 a is switched on. During the first test mode, the voltage connection U₂ or the corresponding connection side U₂ₐ, U_{2b} (high side and low side) of the drive inverter 3 is therefore connected to the supply voltage U₁.

The first test mode can therefore be carried out during ongoing operation of the electrical machine 2. In addition, the first test mode can be carried out cyclically at virtually any desired intervals of time, the respective switching branches 21a, 22a and 21 b, 22b of the two test channels 20a and 20b being alternately switched on and off.

In a second test mode, the functionality and functional safety of the connecting and interrupting circuit 20 are tested in order to determine whether a functionally safe connection between the voltage connection U₂ of the drive inverter 3 and the reference potential (ground) of the supply voltage U₁ is reliably ensured in a fault-free manner after the connection between the voltage connection U₂ of the drive inverter 3 and the supply voltage U₁ has been interrupted.

This connection U₁, U₂ is interrupted by appropriately driving the semiconductor switches T1a, T2a of the two test channels 20a, 20b using the control and/or regulating device 6 via the corresponding inputs SWa1, SWa2 of the connecting and isolating circuit 20. In this case, the semiconductor switch T3a of the isolating circuit 23a turns on and is therefore switched on when the semiconductor switch T4a, which is arranged in series downstream, turns off and is therefore switched off at the same time or alternately in the two test channels 20a, 20b, again preferably in a cyclical manner with likewise virtually any desired cycle times, by the control and/or regulating device 6 via the inputs DISa1, DISa2 of the connecting and isolating circuit 20. In this state, the voltage level at the center tap 24a is queried via the output OUTa. If the level at the center tap 24a has assumed the voltage level of the voltage connection U₂, safe functionality is assumed.

The semiconductor switch T4a then changes to the on state and is therefore switched on, while the semiconductor switch T3a arranged in series upstream changes to the off state and is therefore switched off. If the semiconductor switch T3a, T4a detects a level close to the reference potential (ground) of the supply voltage U₁ at the center tap 24a in this switching state, the functional safety of the isolating circuit 23a can also in turn be assumed.

If, in a further test within the second test mode, when the two semiconductor switches T3a, T4a are switched off, the signal detected via the output OUTa assumes a level which is predefined by the resistors R3a, R4a, the functionality of the isolating circuit 23a is additionally verified.

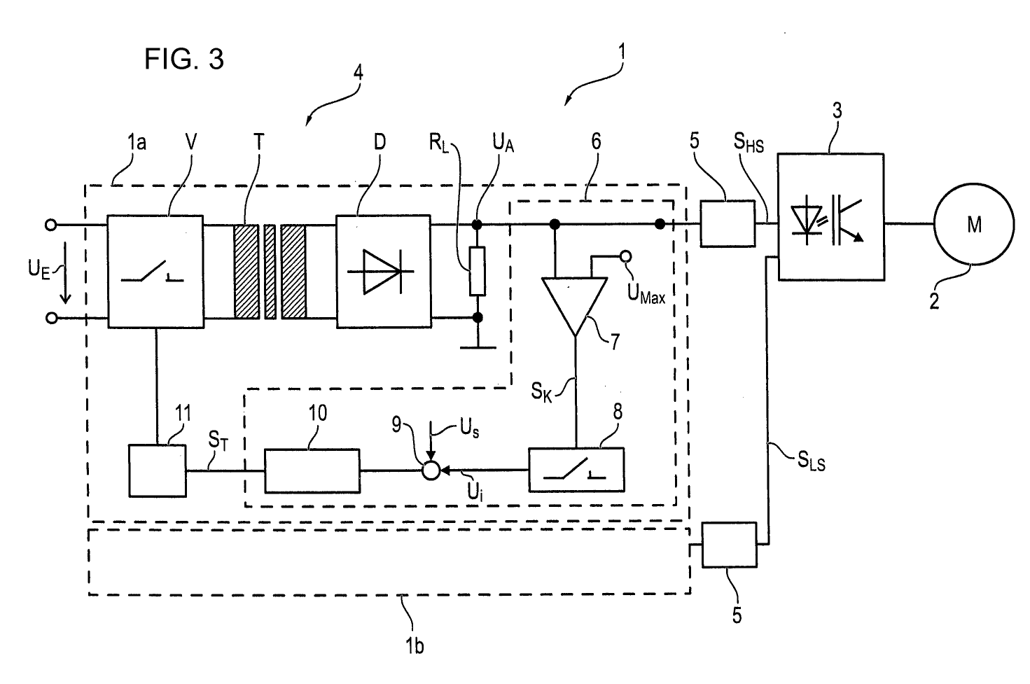

FIG. 3 shows the drive controller 1 including a safety function, in particular the safe-torque-off function (STO), of the three-phase motor 2 as an electrical machine which is operated using the drive inverter 3. The clocked converter circuit 4 having the transformer T and a semiconductor switch V on the primary side and a rectifier D on the secondary side is again shown. The converter circuit 4 converts a DC input voltage U_{E} into a DC output voltage U_{A} which can be tapped off at a load resistor R_{L} connected to ground or reference potential. The voltage transformation or conversion is carried out using the electronic semiconductor switch V, which is driven at a particular switching or operating frequency, and using the transformer T for DC-isolated energy transmission and using the rectifier D for coupling out the DC output voltage U_{A}.

In this case, the transformer T may operate as an energy store of a clocked flyback converter with DC isolation between the converter input and the converter output or else as a DC-isolating component of a so-called forward converter. In both converter variants, the semiconductor switch V is regularly opened in a controlled manner, with the result that the magnetic field in the transformer T can dissipate. The input voltage may be U_{E}=3 V to U_{E}=60 V, for example.

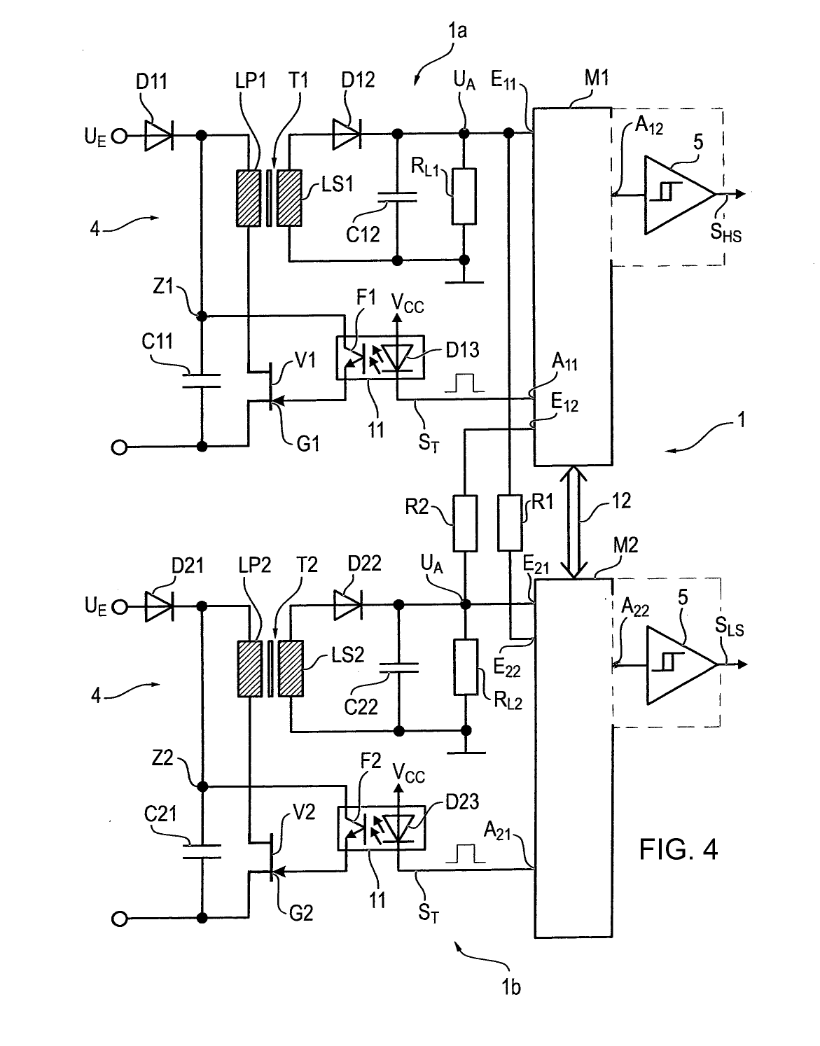

The output voltage U_{A} is passed to a threshold value switch 5 preferably in the form of a Schmitt trigger which generates a binary control signal for the drive inverter 3. This switch function or Schmitt trigger functionality is preferably implemented using software (or in the form of an algorithm) and is integrated in the microprocessor M1, M2 explained below using FIG. 4. If the output voltage U_{A} exceeds an upper threshold value U₁, for example U₁=11 V, the threshold value switch 5 provides a binary control signal S_{HS} having a high level, with the result that the drive inverter 3 connected downstream of the threshold value switch 5 drives the three-phase motor 2 as intended. If the output voltage U_{A} undershoots a lower threshold value U₂, for example U₂=5 V, the threshold value switch 5 generates, as the binary control signal S_{HS}, a low level which triggers the safety function, in particular the safe torque switching-off (safe-torque-off) and therefore the safe stopping of the three-phase motor 2.

The control and/or regulating device 6 passes the output voltage U_{A} generated using the converter circuit 4 to the threshold value switch 5 for the purpose of controlling the drive inverter 3, the output voltage U_{A} being converted into the binary or digital control signal S_{HS}, S_{LS}. Depending on the high level or low level, the control signal S_{HS} activates or deactivates the high side (HS) of the bridge circuit of the drive inverter 3, which is usually constructed from power semiconductors (circuit breakers or power semiconductor switches), in particular IGBTs, in order to signal its intended operation or to trigger the safety function.

A control signal S_{LS} which is produced in the same manner and is again converted into a binary control signal S_{LS} using a threshold value switch 5 controls (activates or deactivates) the low side (LS) of the bridge circuit of the drive inverter 3 in a similar manner. For this purpose, provision is made of two control modules 1a, 1b which have the same structure and are also referred to as the high-side or HS control module 1a and the low-side or LS control module 1b below.

The control and/or regulating device 6 may have a threshold value switch 7 in the form of a comparator, to the input of which the output voltage U_{A} of the converter circuit 4 is supplied. The comparator 7 compares the output voltage U_{A} with a maximum value U_{Max} which is U_{Max}=60 V, for example. If this maximum value U_{Max} is exceeded, the comparator 7 generates, on the output side, a control or switching signal S_{K}, as a result of which a switch 8 which is again implemented by a semiconductor switch or the like, for example, passes the output voltage U_{A} to a desired/actual comparator 9. This functionality can be substituted and/or supplemented by specifying or setting a fixed duty ratio.

If the actual value Uᵢ of the output voltage U_{A} deviates from a desired value U_{S} which is the input voltage U_{E}=U_{S}=24 V for example, a regulator 10, preferably a PWM regulator, generates a clock signal S_{T} for the modified driving of the semiconductor switch V. In this case, the semiconductor switch V is driven using a DC-isolating element 11, preferably in the form of an optocoupler. The regulator 10 is used to set the duty factor of the pulse modulation, for example of a pulse width modulation (PWM) and/or of a pulse pause modulation (PPM), in such a manner that the output voltage U_{A} is set or reduced to the desired value U_{S}.

The transformer T is periodically connected, on the primary side, to the input voltage U_{E} using the semiconductor switch V and, for this purpose, is operated at a particular, constant clock or operating frequency as long as the output voltage U_{A} undershoots the predefined maximum voltage U_{Max}. The control or regulation via the threshold value switch or comparator 7 begins only when this maximum voltage U_{Max} is exceeded, with the result that the transmission of energy via the transformer T is reduced and the output voltage U_{A} is regulated or controlled to the predefined desired voltage U_{S} by changing the clock or operating frequency of the semiconductor switch V. The control and/or regulating device 6 and the converter circuit 4 therefore provide safe operation even in the case of a comparatively high input voltage U_{E} of greater than or equal to 60 V without adversely affecting the required safety function of the electrical machine 2.

FIG. 4 shows a preferred structure of the converter circuit 4. The latter is connected, on the output side, to an input E₁₁ of a microprocessor M1 in which the functionality of the comparator 7 and of the switch 8 and of the comparator 9 and of the regulator 10 is implemented using programming. Together with the converter circuit 4 arranged upstream, the microprocessor M1 forms the first or HS control module 1a of the apparatus 1.

The second or LS control module 1b has a similar structure and again has a redundant, identical converter circuit 4 and a correspondingly redundant microprocessor M2 for implementing the functionality of the control and/or regulating device 6. The redundant microprocessors M1 and M2 are connected, via outputs A₁₂, A₂₂, to the respective Schmitt trigger 5 which in turn provides the drive inverter 3 with the binary control signals S_{HS} and S_{LS} while ensuring the safety function of the electrical machine 2. As already mentioned, the functionality of the threshold value switches (Schmitt triggers) 5 is preferably integrated in the microprocessors M1, M2 using software.

The microprocessors M1, M2 are coupled to one another via resistors R1 and R2. Further couplings of the microprocessors M1 and M2 are indicated by the arrow 12 which symbolizes data or information interchange between the microprocessors M1, M2. In order to couple the microprocessors M1, M2, their inputs E₁₁, E₂₁, via which the output voltage U_{A} of the converter circuit 4 is supplied, are connected to a respective further input E₁₂, E₂₂ of the microprocessors M1 and M2 by the resistors R1, R2.

When the converter circuits 4 have an identical structure, the semiconductor switch V1, V2 is connected in series downstream of the respective primary winding LP1, LP2 of the transformer T1 and T2. A buffer capacitor C11 and C21 is connected in parallel with the series circuit which is preferably connected to the input voltage U_{E} via a diode D11, D21 as polarity reversal protection and contains the respective primary winding LP1, LP2 and the semiconductor switch V1, V2. A rectifier diode D21, D22 is connected in series downstream of the secondary coil LS1, LS2 of the respective transformer T1, T2 and a smoothing capacitor C12, C22 is connected in parallel with the rectifier diode and in turn has the load resistor R_{L1} and R_{L2} connected in parallel with it.

In the embodiment according to FIG. 4, the control and/or regulating device 6 is implemented by a comparator and threshold value switch functionality which is integrated in the microprocessors M1, M2 using programming. The semiconductor switch V1, V2 which is preferably in the form of a MOSFET is connected, on the drive side (on the gate side), via the optocoupler 11 as a DC-isolating element inside the feedback loop, to a corresponding clock output A₁₁, A₂₂ of the respective microprocessor M1 and M2. As symbolically illustrated, the clock signal S_{T} generated is a square-wave signal which periodically connects the light-emitting diodes (LED) D13, D23 of the optocoupler 11 to a supply voltage V_{CC}, with the result that it is alternately bright or dark. Consequently, the phototransistor F1, F2 of the respective optocoupler 11 is periodically switched on or off and therefore passes the voltage level of a tap Z1, Z2 of the buffer capacitor C11, C21 to the control input (gate) G1, G2 of the respective semiconductor switch V1 and V2.

Consequently, the respective semiconductor switch V1, V2 periodically connects the primary coil LP1, LP2 of the transformer T1 and T2 to the input voltage U_{E}. Depending on the respectively set operating frequency or the duty factor predefined using control or regulating technology, the output voltage U_{A} is set on the secondary side of the transformer T1, T2 downstream of the rectifier D12, D22 at the capacitor C12, C22 and the load resistor R_{L1}, R_{L2} and is supplied to the respective microprocessor M1 and M2 as the input voltage.

The described functionality of threshold value switching when the maximum value U_{Max} of the output voltage U_{A} or of the input voltage U_{E} is reached or exceeded and the functionality of generating the clock for the semiconductor switch V1, V2 are installed in the microprocessors M1, M2 in the form of software or an algorithm. The functionalities for carrying out the two test modes of the connecting and interrupting circuit 20 are likewise installed in the microprocessors M1, M2 and therefore in the control and/or regulating device 6, preferably using programming in the form of software or an algorithm.

On account of the redundancy of the two control modules 1a and 1b and on account of their coupling and mutual monitoring, the safety function is always triggered whenever one of the control modules 1a or 1b performs a malfunction or fails completely. This ensures a high degree of intrinsic safety and therefore, overall, a high degree of safety of the drive controller 1.

The invention is not restricted to the exemplary embodiment described above. Rather, other variants of the invention may also be derived therefrom by a person skilled in the art without departing from the subject matter of the invention. In particular, all individual features described in connection with the exemplary embodiment can also be combined with one another in another manner without departing from the subject matter of the invention.

The following is a summary list of reference numerals and the corresponding structure used in the above description of the invention:
1 Control apparatus
1a HS control module
1b LS control module
2 Machine/three-phase motor
3 Frequency converter
4 Converter circuit
5 Threshold value switch/Schmitt trigger
6 Control/regulating device
7 Threshold value switch/comparator
8 Switch
9 Desired/actual comparator
10 PWM regulator
11 Element/optocoupler
12 Data arrow
19 Connection
20 Connecting/interrupting circuit
20a, b Test channel
21, 22 Switching branch
23 Isolating/grounding circuit
24 Center tap
25 Voltage divider
26 Divider/potential tap
A₁₂, A₂₂ Output
C11, C21 Buffer capacitor
C12, C22 Smoothing capacitor
D1, 2 Diode
D11, D21 Polarity reversal protection diode
D12, D22 Rectifier diode
D13, D23 Light-emitting diode (LED)
DIS1, 2 Input
E₁₁, E₂₁ First input
E₁₂, E₂₂ Second input
F1, F2 Phototransistor
G1, G2 Control input/gate
LP1, LP2 Primary winding
LS1, LS2 Secondary winding
M1, M2 Microprocessor
OUT Output
R1, R2 Resistor
R3, R4 Resistor
R_{L1}, R_{L2} Load resistor
SA1, 2 Sensor tap
S1, 2 Sensor signal
SE1, 2 Output
SW1, 2 Input
Sₖ Control/switching signal
S_{T} Drive signal
S_{HS} High-side control signal
S_{LS} Low-side control signal
T₁, T₂ Transformer
T1, 2 Semiconductor switch
T3, 4 Semiconductor switch
U₁ Supply voltage
U₂ Voltage connection
U_{1a, b} Connection side
U_{A} Output voltage
U_{E} Input voltage
Uᵢ Actual value
U_{S} Desired value
U_{Max} Maximum value
V₁, V₂ Semiconductor switch
Z₁, Z₂ Tap

1. An apparatus for connecting and safely isolating a voltage connection of a drive inverter for an electrical machine to and from a supply voltage, the apparatus comprising:
a connecting and interrupting circuit having two switching branches connected between a connection for the supply voltage and the voltage connection of the drive inverter, said connecting and interrupting circuit further having a drivable isolating or grounding circuit and the voltage connection of the drive inverter being connected to a reference potential of the supply voltage via said drivable isolating or grounding circuit; and
a control and/or regulating device set up, in terms of at least one of circuitry or programming, to connect the supply voltage to the voltage connection of the drive inverter via said switching branches and, in a first test mode, to switch off one of said switching branches and to read a sensor signal from said one switching branch, while the other said switching branch is switched on and passes the supply voltage to the voltage connection of the drive inverter.

2. The apparatus according to claim 1, wherein:
said switching branches each have a semiconductor switch, connected between the connection for the supply voltage and the voltage connection of the drive inverter;
said switching branches each having a drive side connected to said control and/or regulating device;
said switching branches each have a sensor tap connected to said control and/or regulating device.

3. The apparatus according to claim 2, wherein:
said switching branches each having a diode; and
said sensor tap is connected between said semiconductor switches and said diode.

4. The apparatus according to claim 1, wherein:
said connecting and interrupting circuit has first and second connection sides and two test channels, said two test channels including a first test channel having an output side connected to said first connection side, and a second test channel having an output side connected to said second connection side for connecting to the voltage connection of the drive inverter.

5. The apparatus according to claim 1, wherein said control and/or regulating device is set up, in terms of at least one of circuitry or programming, to interrupt a connection established via said switching branches between the supply voltage and the voltage connection of the drive inverter, as a result of a safety function being triggered.

6. The apparatus according to claim 1, wherein said drivable isolating or grounding circuit contains two semiconductor switches which are connected in series, can be driven by said control and/or regulating device and has a center tap connected to said control and/or regulating device.

7. The apparatus according to claim 6, wherein said drivable isolating or grounding circuit has a voltage divider which is connected in parallel with said semiconductor switches and has a voltage tap connected to said control and/or regulating device.

8. The apparatus according to claim 7, wherein during an interruption of a connection established via said switching branches between the supply voltage and the voltage connection of the drive inverter, said control and/or regulating device generates a control signal for said drivable isolating or grounding circuit, with a result that the voltage connection of the drive inverter is connected to the reference potential of the supply voltage.

9. The apparatus according to claim 6, wherein when the voltage connection of the drive inverter is isolated from the supply voltage, said control and/or regulating device records a voltage at said center tap of said semiconductor switches in a second test mode when a first of said two semiconductor switches of said drivable isolating or grounding circuit is switched on and a second of said two semiconductor switches is switched off and/or when said second of said two semiconductor switches of said drivable isolating or grounding circuit is switched on and said first of said semiconductor switches is switched off.

10. The apparatus according to claim 8, when the voltage connection of the drive inverter is isolated from the supply voltage, said control and/or regulating device records a voltage at said center tap of said semiconductor switches or at said voltage tap of said voltage divider in a second test mode when both said semiconductor switches of said drivable isolating or grounding circuit are switched off.

11. The apparatus according to claim 1, further comprising a converter circuit having a transformer with, on a primary side, a semiconductor switch for providing a potential-isolated output voltage from an input voltage and has, on a secondary side, a rectifier connected downstream to said control and/or regulating device, said control and/or regulating device being set up, in terms of circuitry and/or programming, to generate a control signal for the drive inverter for triggering a safety function and a drive signal for said semiconductor switch when the potential-isolated output voltage exceeds a maximum value.

12. The apparatus according to claim 11, wherein said control and/or regulating device has a comparator and threshold value switch function to which the potential-isolated output voltage of said converter circuit is applied and the potential-isolated output voltage activating the drive signal for said semiconductor switch.

13. The apparatus according to claim 11, wherein said control and/or regulating device contains a desired/actual comparator and a pulse modulator connected downstream of said comparator and sets an operating frequency of said semiconductor switch on a basis of a deviation of the potential-isolated output voltage of said converter circuit from a desired voltage value.

14. The apparatus according to claim 11, further comprising a DC-isolating element, said semiconductor switch is connected, on a control side, to said control and/or regulating device via said DC-isolating element.

15. The apparatus according to claim 11, further comprising a threshold value switch connected downstream of or is assigned to said control and/or regulating device, the potential-isolated output voltage of said converter circuit being supplied to said threshold value switch function for generating a binary control signal for the driver inverter being a frequency converter, the control signal carrying a high level for operating the frequency converter when the potential-isolated output voltage exceeds an upper threshold value, and the control signal carrying a low level which triggers the safety function when the potential-isolated output voltage undershoots a lower threshold value.

16. A method for connecting and safely isolating a voltage connection of a drive inverter for an electrical machine to and from a supply voltage, which comprises the steps of:
passing the supply voltage to the voltage connection of the drive inverter via a connecting and isolating circuit having two switching branches, one of the switching branches being switched off in a first test mode and a sensor signal being read from the one switching branch, while the other of the switching branches is switched on and passes the supply voltage to the voltage connection of the drive inverter;
detecting, via the sensor signal, whether the switched-off switching branch is operational to pass the supply voltage to the voltage connection of the drive inverter or to isolate the voltage therefrom; and
connecting the voltage connection of the drive inverter which is isolated from the supply voltage to a reference potential of the supply voltage via a controllable isolating or grounding circuit.

17. The method according to claim 16, wherein when the voltage connection of the drive inverter is isolated from the supply voltage, a first semiconductor switch is switched-on in a second test mode and a second semiconductor switch of the controllable isolating or grounding circuit which is in series with the first semiconductor switch is switched off and/or the second semiconductor switch is switched on and the first semiconductor switch is switched off and a voltage of the controllable isolating or grounding circuit is then recorded and is evaluated for testing a function of the controllable isolating or grounding circuit.

18. The method according to claim 17, wherein in the second test mode, recording a voltage at a tap of a voltage divider of the controllable isolating or grounding circuit and evaluating the voltage to test its function when both of the semiconductor switches of the controllable isolating or grounding circuit are switched off.

19. The method according to claim 16, which further comprises:
generating a potential-isolated output voltage from an input voltage;
using the potential-isolated output voltage to generate a control signal for the drive inverter for operation of the drive inverter and for triggering a safety function and to generate a drive signal for a semiconductor switch which is periodically connected to the input voltage, and the potential-isolated output voltage is limited if it exceeds a switching threshold.
